(19) United States
(12) Patent Application Publication
(10) Pub. No.: US 2022/0327292 A1
(43) Pub. Date: Oct. 13, 2022

(54) MULTILINGUAL TRANSLATOR

(71) Applicant: UNIVERSITAT POLITÈCNICA DE CATALUNYA, Barcelona (ES)

(72) Inventors: Marta RUIZ COSTA-JUSSÀ, Sabadell (ES); Carlos ESCOLANO PEINADO, Cornella de Llobregat (ES); José Adrián RODRÍGUEZ FONOLLOSA, Barcelona (ES)

(73) Assignee: UNIVERSITAT POLITÈCNICA DE CATALUNYA, Barcelona (ES)

(21) Appl. No.: 17/229,657

(22) Filed: Apr. 13, 2021

(51) Int. Cl. G06F 40/47; G06F 40/58

(52) U.S. Cl. CPC G06F 40/47; G06F 40/58

(57) ABSTRACT

Multilingual translators are provided with a plurality of input languages, a plurality of output languages, and a plurality of translation directions each of which from one of the input languages to one of the output languages. Multilingual translators include an encoder for each of the input languages and a decoder for each of the output languages. Each of the encoders is trained or trainable to translate from its input language to an arbitrary intermediate representation shared by all the translation directions and, furthermore, has its own encoding parameters or weights that are independent from the other encoders. Each of the decoders is trained or trainable to translate from the arbitrary intermediate representation to its output language and, besides, has its own decoding parameters or weights that are independent from the other decoders. Methods, computing systems, and computers programs for training such multilingual translators are also provided.

This disclosure relates to multilingual translators and methods of training such multilingual translators, and to computer programs, systems and computer systems that are suitable to perform said methods of training multilingual translators.

### BACKGROUND

There exist different multilingual systems and approaches of training them. Pair-wise or pivot-based systems are the most pervasive ones in commercial applications. Pair-wise systems learn all possible language combinations independently from each other. Pivot-based systems use an intermediate language to learn those pairs that cannot be learned directly (e.g., Catalan-Urdu may be addressed by Catalan-English-Urdu). However, recent multilingual systems which learn all languages at the same time tend to offer better quality, especially for low resources languages. Generally, multilingual approaches that are trained with several languages at once require retraining the entire system to add a new language or modality. For example, multilingual machine translation systems are capable of translating an input sequence of words in one language for which the system was trained. When adding a new language, previous ones have to be retrained together with the new one. This is computationally expensive and also varies the quality of translation in all languages.

An object of the present disclosure is to provide new multilingual translators and systems, methods and computer programs aimed at improving current multilingual translators and manners of training said multilingual translators.

### SUMMARY

In an aspect, multilingual translators are provided with a plurality of input languages, a plurality of output languages, and a plurality of translation directions each of which from one of the input languages to one of the output languages. These multilingual translators include an encoder for each of the input languages and a decoder for each of the output languages. Each of the encoders is trained or trainable to translate from its input language to an arbitrary intermediate representation shared by all the translation directions and, furthermore, has its own encoding parameters or weights that are independent from the other encoders. Each of the decoders is trained or trainable to translate from the arbitrary intermediate representation to its output language and, besides, has its own decoding parameters or weights that are independent from the other decoders.

The proposed multilingual translators may be trained in different manners such as the ones described in other parts of the disclosure, in such a manner that their training results more efficient and more accurate. It has been experimentally checked that the intermediate representation's arbitrariness and the non-sharing of encoding parameters between encoders and of decoding parameters between decoders makes the proposed multilingual translators trainable more efficiently and accurately. Since encoders can learn independently from each other and decoders can learn independently from each other through same arbitrary intermediate representation, it has been experimentally proved that encoders and decoders result very well trained to translate from input to output languages through globally converging to the arbitrary intermediate representation.

Since already trained decoders have learnt to translate by converging to the arbitrary intermediate representation, any of them may be reused to incrementally train a new encoder (of a new translation direction) based on adjusting its encoding parameters and thereby converging to the arbitrary intermediate representation shared by all the translation directions. Similarly, since already trained encoders have learnt to translate by converging to the arbitrary intermediate representation, any of them may be reused to incrementally train a new decoder (of a new translation direction) based on adjusting its decoding parameters and thereby converging to the arbitrary intermediate representation shared by all the translation directions. That is, new translation directions may be added by simply training corresponding new encoder or decoder, without the need of retraining encoders or decoders that have been already trained.

In some examples, each of the encoders and decoders may be based on any known neural model, such as e.g. recurrent neural network, convolutional neural network, transformer, or any combination thereof. According to implementations, the arbitrary intermediate representation shared by all the translation directions may be or may correspond to a matrix-based or vectorial representation or a combination thereof.

In some configurations, at least some of the encoders and decoders may be text encoders and text decoders, respectively, and/or at least some of the encoders may be speech encoders. Multilingual translators according to present disclosure that are configured to translate from text and speech may be denominated multilingual multimodal translators. The term “multimodal” is thus used herein to indicate such a duality of translation modes, i.e. text and speech.

In a further aspect, methods are provided of “massively” training a multilingual translator such as the ones disclosed in other parts of the disclosure. The term “massive” or “massively” is used herein to indicate that several encoders and decoders are trained at the same time to translate from several input languages to several output languages, and/or large sets of training data are used for such a simultaneous training. These “massive” training methods include iteratively providing, for each of the translation directions, the encoder and decoder of the translation direction with respective input and output training-data pair that includes input training-data in the encoder's input language and output training-data in the decoder's output language. Said output training-data to be expectedly outputted by the decoder in response to the input training-data through the arbitrary intermediate representation. In each of said iterations, the encoders and decoders are simultaneously provided with the respective input and output training-data pair having same significance for all the translation directions, thereby causing adjustment of the encoders' encoding parameters and decoders' decoding parameters, so that the encoders and decoders result trained to translate from input to output languages through converging to the arbitrary intermediate representation.

The suggested “massive” training methods may be used to efficiently and accurately configure multilingual translators proposed herein to translate from input to output languages, without the need of any retraining when new translation directions are added. Since encoders and decoders are simultaneously provided with training data having same significance, each of the encoders learns independently from the others and each of the decoders learns independently from the others by converging to the arbitrary intermediate representation. This convergence of the encoders and decoders to the arbitrary intermediate representation makes the translator incrementally trainable without the need of retraining already trained encoders/decoders.

In accordance with examples, methods may be provided for “input-focused incrementally” training a multilingual translator that has been previously trained with any of the massive training methods disclosed in other parts of the disclosure, with the aim of adding a new translation direction from a new input language to a pre-existing output language. These “input-focused incremental” training methods may include freezing the pre-existing decoder whose output language is the pre-existing output language, such that the pre-existing decoder's decoding parameters are set as non-modifiable. These “input-focused incremental” training methods may further include iteratively providing a new encoder and the frozen pre-existing decoder of the new translation direction with respective input and output training-data pair including input training-data in the new input language and output training-data in the pre-existing output language. Said output training-data to be expectedly outputted by the frozen pre-existing decoder in response to the input training-data through the arbitrary intermediate representation, thereby causing adjustment of the new encoder's encoding parameters in such a way that the new encoder results trained to translate from the new input language through converging to the arbitrary intermediate representation.

The proposed “input-focused incremental” training methods may thus provide a very efficient and accurate manner of adding a new translation direction with new input language, based on only training new encoder of the new translation direction in connection with corresponding pre-existing decoder in frozen or non-trainable state. The term “input-focused” is used herein to indicate that new input language is added and, therefore, only encoding parameters of new encoder are adjusted with the training.

In some implementations, the new encoder may be a new speech encoder and the pre-existing decoder may be a pre-existing text decoder, in which case “input-focused incremental speech-to-text” training methods may be provided. The term “speech-to-text” is thus used herein to indicate a translation direction from input speech language to output text language.

These “input-focused incremental speech-to-text” training methods may include a first projection, a second projection and final addition. First projection may include projecting values or points generated by the new speech encoder within the arbitrary intermediate representation into an arbitrary middle representation with larger or smaller dimensionality than the arbitrary intermediate representation. Second projection may include projecting values or points resulting from the projection into the arbitrary middle representation back into the arbitrary intermediate representation. Final addition may include adding values or points resulting from the projection back into the arbitrary intermediate representation to the values or points generated by the new speech encoder before the projection into the arbitrary middle representation.

The dimensionality of the arbitrary middle representation may be larger or smaller than the arbitrary intermediate representation depending on an accuracy level achieved with the larger or smaller dimensionality. Projecting from arbitrary intermediate representation into smaller arbitrary middle representation may create information bottleneck that may help the training to effectively focus on more relevant information. Projecting from arbitrary intermediate representation into larger arbitrary middle representation may provoke an over parametrization that may help to capture more critical information from the representation. Projecting into either smaller or larger dimensionality may produce more or less accurate translation results, so the one or the other dimensionality may be selected depending on whether better or worse results are obtained.

Adding speech has been more challenging than text due to differences between the two data modalities. Speech utterances usually have an order of magnitude more elements than their text transcriptions and, therefore, individual samplings have more limited semantic value compared to words or sub-words in text data. With the proposed first and second projections and final addition, values or points received by the pre-existing text decoder may be e.g. less noisy and/or richer and/or better relocated within the arbitrary intermediate representation, such that improved translation results may be obtained.

Examples of “input-focused incremental speech-to-text” training methods may further include normalizing the values or points generated by the new speech encoder before the projection into the arbitrary middle representation. Such a normalization may cause “statistical” adjustment or relocation of values/points within the arbitrary intermediate representation to notionally common space, often prior to further processing, or even more sophisticated adjustments to bring entire probability distributions of adjusted values into alignment.

Some “input-focused incremental speech-to-text” training methods may further include pre-training the new speech encoder with an auxiliary text decoder before its training with the pre-existing text decoder. This pre-training may include iteratively providing the new speech encoder and the auxiliary text decoder with respective input and output training-data pair including input speech training-data in the new input language and output text training-data in the same new input language. Said output text training-data to be expectedly outputted by the auxiliary text decoder in response to the input speech training-data, thereby causing pre-adjustment of the speech encoder's encoding parameters in such a way that the posterior training of the new speech encoder with the pre-existing text decoder will result more accurate with less input and output training-data.

As commented before, adding speech has been more challenging than text due to differences between the two data modalities. The suggested pre-training may help to attenuate said difficulties by providing a good initialization of the new speech encoder's encoding parameters, thereby allowing a lighter posterior training of the new speech encoder in comparison to performing said posterior training without the proposed pre-training.

In accordance with examples, methods may be provided for “output-focused incrementally” training a multilingual translator that has been previously trained with any of the massive training methods disclosed in other parts of this disclosure, with the aim of adding a new translation direction from a pre-existing input language to a new output language. These “output-focused incremental” training methods may include freezing the pre-existing encoder whose input language is the pre-existing input language, such that the encoding parameters of the pre-existing encoder are set as non-modifiable. The “output-focused incremental” training methods may further include iteratively providing the frozen pre-existing encoder and a new decoder of the new translation direction with respective input and output training-data pair including input training-data in the pre-existing input language and output training-data in the new output language. Said output training-data to be expectedly outputted by the new decoder in response to the input training-data through the arbitrary intermediate representation, thereby causing adjustment of the decoder's decoding parameters, such that the new decoder results trained to translate to the new output language through converging to the arbitrary intermediate representation.

The proposed “output-focused incremental” training methods may thus provide a very efficient and accurate manner of adding a new translation direction with new output language, based on only training new decoder of the new translation direction in connection with corresponding pre-existing encoder in frozen or non-trainable state. The term “output-focused” is used herein to indicate that new output language is added and, therefore, only decoding parameters of new decoder are adjusted with the training.

In a still further aspect, computing systems are provided for training multilingual translators, said computing systems including a memory and a processor, embodying instructions stored in the memory and executable by the processor, the instructions including functionality or functionalities to execute any of the methods of training a multilingual translator disclosed in other parts of the present disclosure.

In a yet further aspect, computer programs are provided including program instructions for causing a computing system to perform any of the methods of training a multilingual translator disclosed in other parts of the present disclosure. These computer programs may be embodied on a storage medium, and/or carried on a carrier signal.

### BRIEF DESCRIPTION OF THE DRAWINGS

Non-limiting examples of the present disclosure will be described in the following, with reference to the appended drawings, in which:

FIG. 1 show schematic representations of multilingual translators according to examples.

FIG. 2 show schematic representations of a computing system for training a multilingual translator such as the ones of FIG. 1, according to examples.

FIG. 3 is a flow chart schematically illustrating “massive” training methods according to examples.

FIG. 4 is a flow chart schematically illustrating “input-focused incremental” training methods according to examples.

FIG. 5 is a flow chart schematically illustrating “input-focused incremental speech-to-text” training methods according to examples.

FIG. 6 is a flow chart schematically illustrating “output-focused incremental” training methods according to examples.

### DETAILED DESCRIPTION OF EXAMPLES

In these figures the same reference signs have been used to designate same or similar elements.

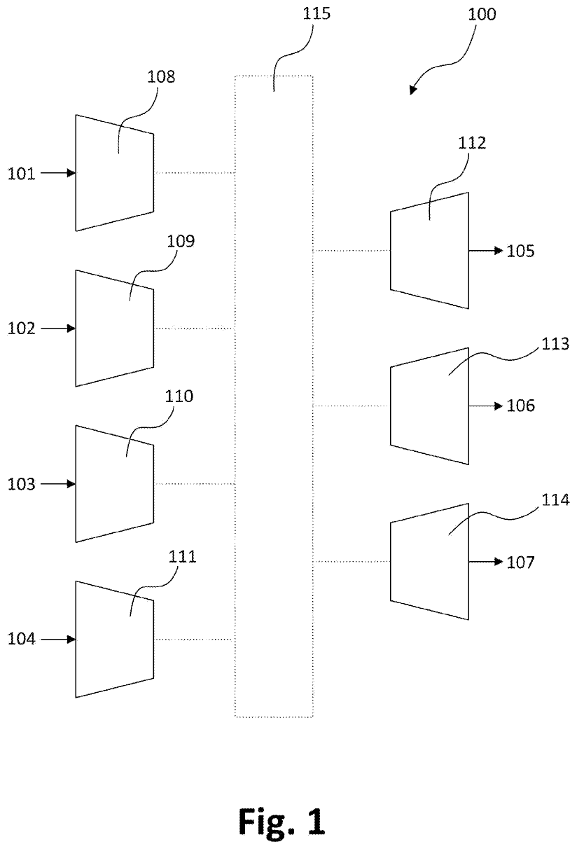

FIG. 1 show schematic representations of multilingual translators according to examples. As shown in this Fig., Multilingual translators 100 according to present disclosure may include a plurality of input languages 101-104, a plurality of output languages 105-107, and a plurality of translation directions each of which from one of the input languages 101-104 to one of the output languages 105-107. Such multilingual translators may include an encoder 108-111 for each of the input languages 101-104, and a decoder 112-114 for each of the output languages 105-107. Each of the encoders 108-111 may be trained (or trainable) to translate from its input language 101-104 to an arbitrary intermediate representation 115 shared by all the translation directions, and may have its own encoding parameters or weights that are independent from the other encoders. Each of the decoders 112-114 may be trained (or trainable) to translate from the arbitrary intermediate representation 115 to its output language 105-107, and may have its own decoding parameters or weights that are independent from the other decoders.

The encoders 108-111 and decoders 112-114 may be based on any known neural model such as e.g. recurrent neural network, convolutional neural network, transformer, or any combination thereof. 4. The arbitrary intermediate representation 115 (shared by all the translation directions) may be or may correspond to a continuous representation based on e.g. a matrix or vectorial representation or a combination thereof. 5. All or part of the encoders 108-111 and decoders 112-114 may be text encoders and text decoders, respectively, and/or in some implementations, some of the encoders 108-111 may be speech encoders. When a multilingual translator includes both text and speech encoder(s), this translator may be denominated herein as multilingual multimodal translator.

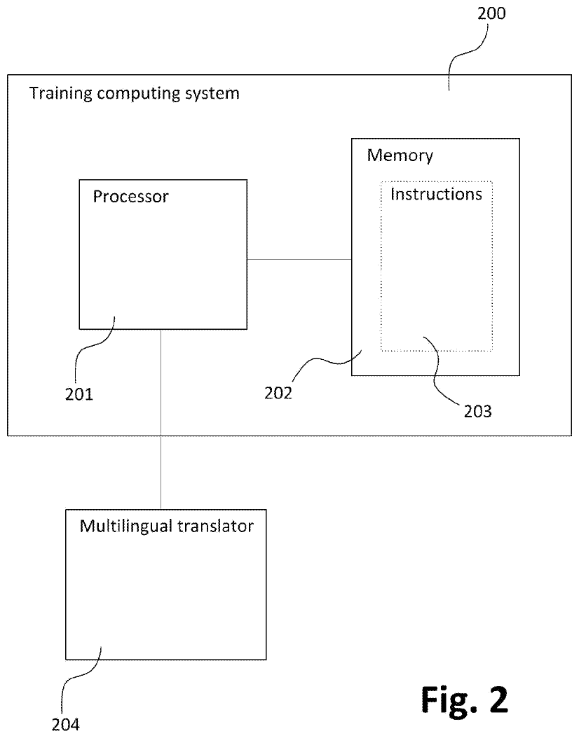

FIG. 2 show schematic representations of a computing system for training a multilingual translator, according to examples. As shown in this Fig., training (computing) systems 200 according to present disclosure may include different modules such as, for example, a memory 202 and a processor 201, embodying instructions 203 stored in the memory 202 and executable by the processor 201. The instructions 203 may include functionality or functionalities to execute any of the methods of training a multilingual translator 204 described in other parts of the disclosure. Any of the multilingual translators according to present disclosure, such as the ones of FIG. 1, may be trained or trainable by training (computing) systems 200 proposed herein.

As used herein, the term “module” may be understood to refer to software, firmware, hardware and/or various combinations thereof. It is noted that the modules are exemplary. The modules may be combined, integrated, separated, and/or duplicated to support various applications. Also, a function described herein as being performed by a particular module may be performed by one or more other modules and/or by one or more other devices instead of or in addition to the function performed by the described particular module.

The modules may be implemented across multiple devices, associated or linked to corresponding methods of training a multilingual translator proposed herein, and/or to other components that may be local or remote to one another. Additionally, the modules may be moved from one device and added to another device, and/or may be included in both devices, associated to corresponding methods of training a multilingual translator proposed herein. Any software implementations may be tangibly embodied in one or more storage media, such as e.g. a memory device, a floppy disk, a compact disk (CD), a digital versatile disk (DVD), or other devices that may store computer code.

The systems for training a multilingual translator according to present disclosure may be implemented by computing devices, systems and/or methods, electronic devices, systems and/or methods or a combination thereof. The computing devices, systems and/or methods may be a set of instructions (e.g. a computer program) and then the systems for training a multilingual translator may include a memory and a processor, embodying said set of instructions stored in the memory and executable by the processor. These instructions may include functionality or functionalities to execute corresponding methods of training a multilingual translator such as e.g. the ones described with reference to the figures.

In case the systems for training a multilingual translator are implemented only by electronic devices, systems and/or methods, a controller of the system may be, for example, a CPLD (Complex Programmable Logic Device), an FPGA (Field Programmable Gate Array) or an ASIC (Application-Specific Integrated Circuit).

In case the systems for training a multilingual translator are a combination of electronic and computing devices, systems and/or methods, the computing devices, systems and/or methods may be a set of instructions (e.g. a computer program) and the electronic devices, systems and/or methods may be any electronic circuit capable of implementing corresponding method-steps of the methods of training a multilingual translator proposed herein, such as the ones described with reference to other figures.

The computer program(s) may be embodied on a storage medium (for example, a CD-ROM, a DVD, a USB drive, a computer memory or a read-only memory) or carried on a carrier signal (for example, on an electrical or optical carrier signal).

The computer program(s) may be in the form of source code, object code, a code intermediate source and object code such as in partially compiled form, or in any other form suitable for use in implementing the methods of training a multilingual translator according to present disclosure. The carrier may be any entity or device capable of carrying the computer program(s).

For example, the carrier may include a storage medium, such as a ROM, for example a CD ROM or a semiconductor ROM, or a magnetic recording medium, for example a hard disk. Further, the carrier may be a transmissible carrier such as an electrical or optical signal, which may be conveyed via electrical or optical cable or by radio or other devices, systems and/or methods.

When the computer program(s) is/are embodied in a signal that may be conveyed directly by a cable or other device or devices, systems and/or methods, the carrier may be constituted by such cable or other device or devices, systems and/or methods. Alternatively, the carrier may be an integrated circuit in which the computer program(s) is/are embedded, the integrated circuit being adapted for performing, or for use in the performance of, the methods of training a multilingual translator proposed herein.

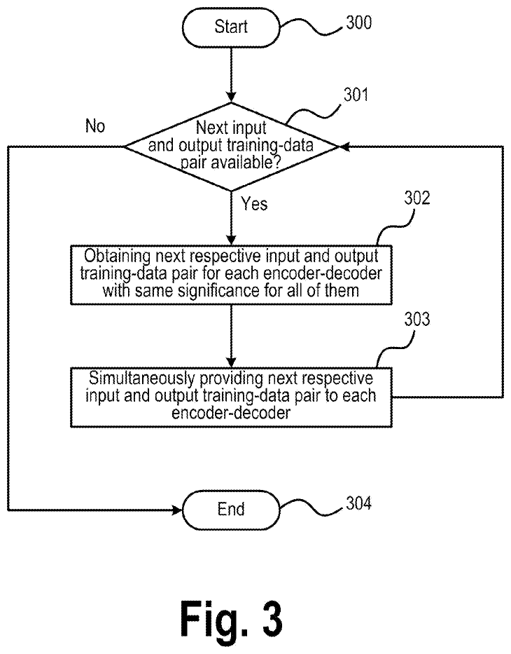

FIG. 3 is a flow chart schematically illustrating “massive” training methods according to examples. As generally shown in the figure, such “massive” training methods may be initiated (e.g. at method block 300) upon detection of a starting condition such as e.g. a user request for starting the method, initiation of system for training multilingual translator, etc. Since methods according to FIG. 3 are performable by systems according to FIG. 2 in connection with translators according to FIG. 1, number references from said FIGS. 1 and 2 may be reused in following description of FIG. 3.

Massive training methods may further include (e.g. at method block 301) verifying if next respective input and output training-data pair is available for each of the encoder-decoder pairs or translation directions. Each of such input and output training-data pairs may include input training-data in the input language 101-104 of corresponding encoder 108-111, and output training-data in the output language 105-107 of corresponding decoder 112-114. The output training-data is data to be expectedly outputted by the decoder 112-114 in response to the input training-data (in same training-data pair) through the arbitrary intermediate representation 115.

In case of positive or true result of the above verification (i.e. next training-data pair is available), massive training methods may continue to obtain (e.g. at method block 302) next respective input and output training-data pair for each of the encoder-decoder pairs (or translation directions) with same significance for all of them. In case of negative or false result of the above verification (i.e. next training-data pair is not available), massive training methods may proceed to terminate the method (e.g. at method block 304).

Once next respective input and output training-data pair (with same simultaneous significance) has been obtained for each of the encoder-decoder pairs, massive training methods may yet further include (e.g. at method block 303) simultaneously providing the encoders 108-111 and decoders 112-114 with the respective input and output training-data pair having same significance for all the translation directions. It has been experimentally and surprisingly checked that this manner of training encoders 108-111 and decoders 112-114 causes proper adjustment of the encoding parameters (or weights) of the encoders 108-111 and decoding parameters (or weights) of the decoders 112-114, in such a way that they result trained to translate from input languages 101-104 to output languages 105-107 through globally converging to the arbitrary intermediate representation 115.

Massive training methods may still furthermore include (e.g. at method block 304) terminating execution of the method when e.g. no more training-data pairs are available (as determined at e.g. block 301) or another type of ending condition is satisfied. Such another ending condition satisfaction may be determined by detecting e.g. a user request for ending the method, or turning off of the system for training multilingual translator, etc.

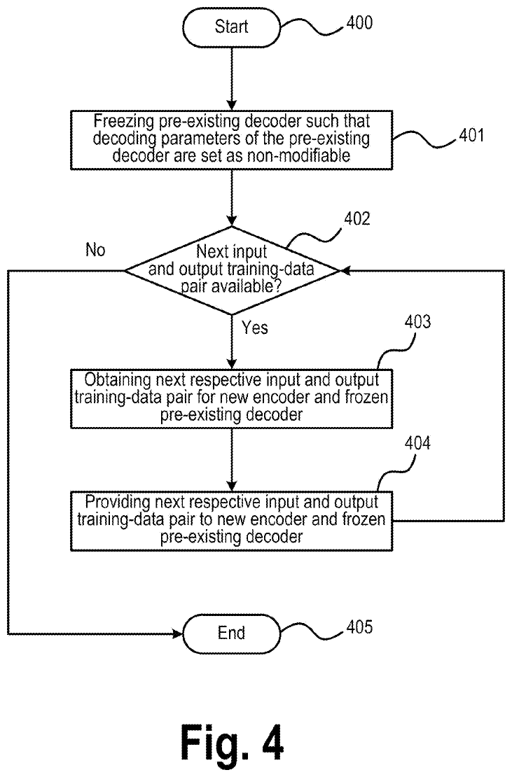

FIG. 4 is a flow chart schematically illustrating “input-focused incremental” training methods according to examples, with the aim of adding a new translation direction from a new input language to a pre-existing output language. As generally shown in the figure, such “input-focused incremental” training methods may be initiated (e.g. at method block 400) upon detection of a starting condition such as e.g. a user request for starting the method, initiation of system for training multilingual translator, etc. Since methods according to FIG. 4 are performable by systems according to FIG. 2 in connection with translators according to FIG. 1, number references from said FIGS. 1 and 2 may be reused in following description of FIG. 4.

Input-focused incremental training methods may further include (e.g. at method block 401) freezing pre-existing decoder whose output language is the pre-existing output language, such that the decoding parameters of the pre-existing decoder are set as non-modifiable.

Input-focused incremental training methods may still further include (e.g. at method block 402) checking if next respective input and output training-data pair is available for a new encoder and the frozen pre-existing decoder forming the new translation direction. Each of such input and output training-data pairs may include input training-data in the new input language, and output training-data in the pre-existing output language. The output training-data is data to be expectedly outputted by the frozen pre-existing decoder in response to the input training-data through the arbitrary intermediate representation 115.

In case of positive or true result of the above checking (i.e. next training-data pair is available), input-focused incremental training methods may continue to obtain (e.g. at method block 403) next respective input and output training-data pair for the new encoder and frozen pre-existing decoder. In case of negative or false result of the above checking (i.e. next training-data pair is not available), input-focused incremental training methods may proceed to terminate the method (e.g. at method block 405).

Once next respective input and output training-data pair (with same simultaneous significance) has been obtained for the new encoder and frozen pre-existing decoder, input-focused incremental training methods may yet further include (e.g. at method block 404) providing the new encoder and frozen pre-existing decoder with the respective input and output training-data pair. It has been experimentally and surprisingly checked that this manner of incrementally training the new encoder and frozen pre-existing decoder causes proper adjustment of the encoding parameters (or weights) of the new encoder, in such a manner that the new encoder results trained to translate from the new input language through converging to the arbitrary intermediate representation. Since the pre-existing decoder has converged previously to the arbitrary intermediate representation (due to e.g. a massive training such as the ones of FIG. 3), the pre-existing decoder is frozen and only the encoding parameters of the new encoder result properly adjusted.

Input-focused incremental training methods may still furthermore include (e.g. at method block 405) terminating execution of the method when e.g. no more training-data pairs are available (as determined at e.g. block 402) or another type of ending condition is satisfied. Such another ending condition satisfaction may be determined by detecting e.g. a user request for ending the method, or turning off of the system for training multilingual translator, etc.

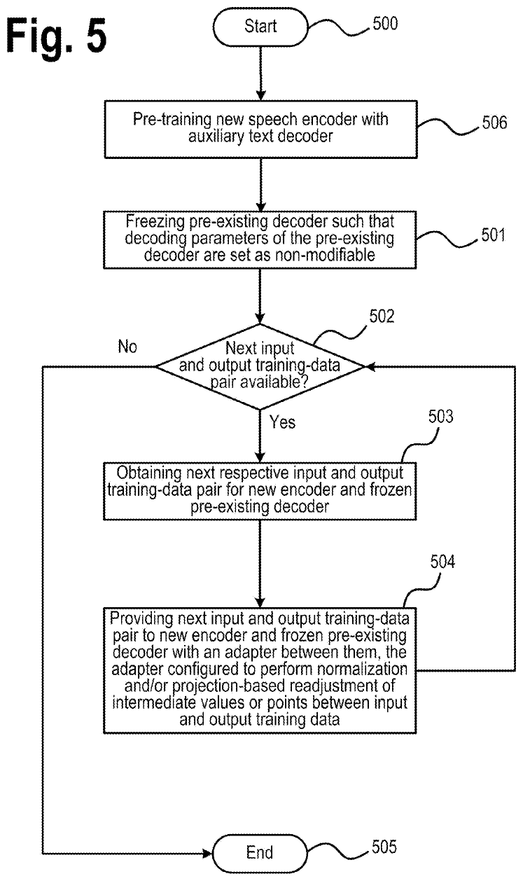

FIG. 5 is a flow chart schematically illustrating “input-focused incremental speech-to-text” training methods according to examples, with the aim of adding a new translation direction from a new input speech language (input of new speech encoder) to a pre-existing output text language (output of pre-existing text decoder). As generally shown in the figure, such “input-focused incremental speech-to-text” training methods may be initiated (e.g. at method block 500) upon detection of a starting condition such as e.g. a user request for starting the method, initiation of system for training multilingual translator, etc. Since methods according to FIG. 5 are performable by systems according to FIG. 2 in connection with translators according to FIG. 1, number references from said FIGS. 1 and 2 may be reused in following description of FIG. 5.

Input-focused incremental speech-to-text training methods may further include (e.g. at method block 506) pre-training the new speech encoder with an auxiliary text decoder before its training with the pre-existing text decoder. This pre-training may include iteratively providing the new speech encoder and auxiliary text decoder with respective input and output training-data pair including input speech training-data (in the new input language) and output text training-data (also in the new input language). Said output text training-data may correspond to data to be expectedly outputted by the auxiliary text decoder in response to the input speech training-data. This manner of pre-training the new speech encoder may cause pre-adjustment of the new speech encoder's encoding parameters, in such a way that the posterior training of the new speech encoder with the pre-existing text decoder to be more accurate with less (or much less) input and output training-data.

Input-focused incremental speech-to-text training methods may further include (e.g. at method block 501) freezing the pre-existing text decoder (whose output language is the pre-existing output text language) such that the decoding parameters of the pre-existing text decoder are set as non-modifiable.

Input-focused incremental speech-to-text training methods may still further include (e.g. at method block 502) determining if next input and output training-data pair is available for the new speech encoder and the frozen pre-existing text decoder constituting the new translation direction. Each of such input and output training-data pairs may include input training-data in the new input speech language and output training-data in the pre-existing output text language. The output training-data is data to be expectedly outputted by the frozen pre-existing text decoder in response to the input training-data through the arbitrary intermediate representation 115.

In case of positive or true result of the above determination (i.e. next training-data pair is available), input-focused incremental speech-to-text training methods may continue to obtain (e.g. at method block 503) next input and output training-data pair for the new speech encoder and the frozen pre-existing text decoder. In case of negative or false result of the above determination (i.e. next training-data pair is not available), input-focused incremental speech-to-text training methods may proceed to terminate the method (e.g. at method block 505).

Once next input and output training-data pair has been obtained, input-focused incremental speech-to-text training methods may yet further include (e.g. at method block 504) providing the obtained input and output training-data pair to the new speech encoder and frozen pre-existing text decoder with an adapter between them. The adapter may be configured to normalize values or points generated by the new speech encoder from the input speech training-data in process, and/or to perform a projection-based readjustment of the previously normalized or non-normalized values from new speech encoder.

The projection-based readjustment may include a first projection, a second projection and a final addition. The first projection may include projecting values or points generated by the new speech encoder within the arbitrary intermediate representation into an arbitrary middle representation with larger or smaller dimensionality than the arbitrary intermediate representation. These values or points to be projected into the arbitrary middle representation may have been normalized previously (as commented before) or without such a previous normalization. The second projection may include projecting values or points resulting from the projection into the arbitrary middle representation back into the arbitrary intermediate representation. The final addition may include adding values or points resulting from the projection back into the arbitrary intermediate representation to the values or points generated by the new speech encoder before their projection into the arbitrary middle representation (with or without previous normalization).

The dimensionality of the arbitrary middle representation may be selected larger or smaller than the arbitrary intermediate representation experimentally, depending on an accuracy level achieved with the larger or smaller dimensionality. Projecting from arbitrary intermediate representation into arbitrary middle representation with smaller dimensionality may create an information bottleneck that may help the translation training to focus on more relevant information. Projecting from arbitrary intermediate representation into arbitrary middle representation with larger dimensionality may provoke an over parametrization that may help to capture critical information from the representation. Depending on the translation scenario, projecting to either smaller or larger dimensionality may produce more or less accurate translation results, so the one or the other dimensionality may be selected depending on whether better or worse results are obtained.

It has been experimentally and surprisingly checked that this manner (according to FIG. 5) of incrementally training the new speech encoder and the frozen pre-existing text decoder causes proper adjustment of the encoding parameters (or weights) of the new speech encoder, in such a manner that the new speech encoder results trained to translate from the new input speech language through converging to the arbitrary intermediate representation. Since the pre-existing text decoder has converged previously to the arbitrary intermediate representation (due to e.g. a massive training such as the ones of FIG. 3), the pre-existing text decoder is frozen and only the encoding parameters of the new speech encoder result properly adjusted.

Input-focused incremental speech-to-text training methods may still furthermore include (e.g. at method block 505) terminating execution of the method when e.g. no more training-data pairs are available (as determined at e.g. block 502) or another type of ending condition is satisfied. Such another ending condition satisfaction may be determined by detecting e.g. a user request for ending the method, or turning off of the system for training multilingual translator, etc.

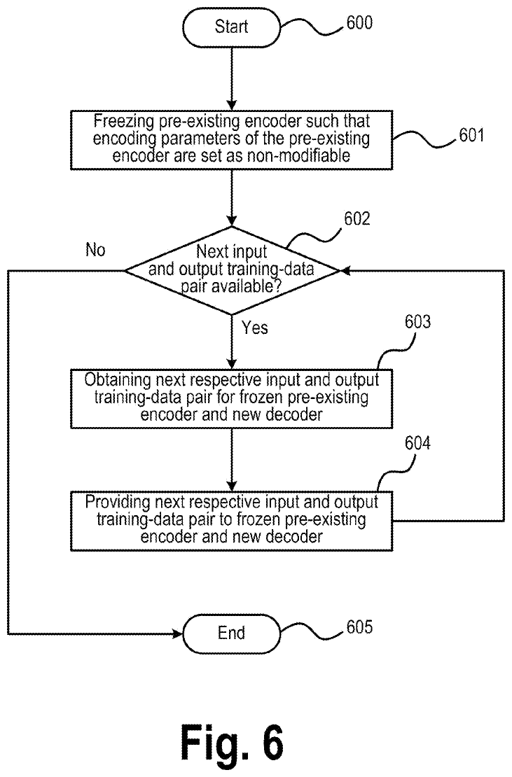

FIG. 6 is a flow chart schematically illustrating “output-focused incremental” training methods according to examples, with the aim of adding a new translation direction from a pre-existing input language to a new output language. As generally shown in the figure, such “output-focused incremental” training methods may be initiated (e.g. at method block 600) upon detection of a starting condition such as e.g. a user request for starting the method, initiation of system for training multilingual translator, etc. Since methods according to FIG. 6 are performable by systems according to FIG. 2 in connection with translators according to FIG. 1, number references from said FIGS. 1 and 2 may be reused in following description of FIG. 6.

Output-focused incremental training methods may further include (e.g. at method block 601) freezing pre-existing encoder whose input language is the new input language, such that the encoding parameters (or weights) of the pre-existing encoder are set as non-modifiable.

Output-focused incremental training methods may still further include (e.g. at method block 602) validating if next input and output training-data pair is available for the frozen pre-existing encoder and new decoder of the new translation direction. Each of such input and output training-data pairs may include input training-data in the pre-existing input language and output training-data in the new output language. The output training-data is data to be expectedly outputted by the new decoder in response to the input training-data through the arbitrary intermediate representation 115.

In case of positive or true result of the above validation (i.e. next training-data pair is available), output-focused incremental training methods may continue to obtain (e.g. at method block 603) next input and output training-data pair for the frozen pre-existing encoder and new decoder. In case of negative or false result of the above validation (i.e. next training-data pair is not available), output-focused incremental training methods may proceed to terminate the method (e.g. at method block 605).

Once next input and output training-data pair has been obtained for the frozen pre-existing encoder and new decoder, output-focused incremental training methods may yet further include (e.g. at method block 604) providing the frozen pre-existing encoder and new decoder with the obtained input and output training-data pair. It has been experimentally and surprisingly confirmed that this manner of incrementally training the frozen pre-existing encoder and new decoder causes proper adjustment of the decoding parameters (or weights) of the new decoder, in such a manner that the new decoder results trained to translate to the new output language through converging to the arbitrary intermediate representation. Since the pre-existing encoder has converged previously to the arbitrary intermediate representation (due to e.g. a massive training such as the ones of FIG. 3), the pre-existing encoder is frozen and only the decoding parameters of the new decoder result properly adjusted.

Output-focused incremental training methods may still furthermore include (e.g. at method block 605) terminating execution of the method when e.g. no more training-data pairs are available (as determined at e.g. block 602) or another type of ending condition is satisfied. Such another ending condition satisfaction may be determined by detecting e.g. a user request for ending the method, or turning off of the system for training multilingual translator, etc.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A multilingual translator with a plurality of input languages, a plurality of output languages, and a plurality of translation directions each of which from one of the input languages to one of the output languages, the multilingual translator comprising:
an encoder for each of the input languages, said encoder being trained or trainable to translate from its input language to an arbitrary intermediate representation shared by all the translation directions; and
a decoder for each of the output languages, said decoder being trained or trainable to translate from the arbitrary intermediate representation to its output language;
each of the encoders having its own encoding parameters or weights that are independent from the other encoders, and
each of the decoders having its own decoding parameters or weights that are independent from the other decoders.

2. A multilingual translator according to claim 1, each of the encoders and decoders being based on a neural model.

3. A multilingual translator according to claim 2, the neural model corresponding to recurrent neural network, convolutional neural network, transformer, or any combination thereof.

4. A multilingual translator according to claim 1, the arbitrary intermediate representation shared by all the translation directions corresponding to a matrix-based or vectorial representation or a combination thereof.

5. A multilingual translator according to claim 1, at least some of the encoders and decoders being text encoders and text decoders, respectively.

6. A multilingual translator according to claim 1, at least some of the encoders being speech encoders.

7. A method of training a multilingual translator according to claim 1, the method comprising:
iteratively providing, for each of the translation directions, the encoder and decoder of the translation direction with respective input and output training-data pair including input training-data in the input language of the encoder, and output training-data in the output language of the decoder to be expectedly outputted by the decoder in response to the input training-data through the arbitrary intermediate representation,
in each of said iterations, providing the encoders and decoders simultaneously with the respective input and output training-data pair having same significance for all the translation directions, thereby causing
adjustment of the encoding parameters of the encoders and the decoding parameters of the decoders, such that the encoders and decoders result trained to translate from input languages to output languages through converging to the arbitrary intermediate representation.

8. A method of training a multilingual translator that has been previously trained with a method according to claim 7, for adding a new translation direction from a new input language to a pre-existing output language, the method comprising:
freezing the pre-existing decoder whose output language is the pre-existing output language, such that the decoding parameters of the pre-existing decoder are set as non-modifiable; and
iteratively providing a new encoder and the frozen pre-existing decoder of the new translation direction with respective input and output training-data pair including input training-data in the new input language, and output training-data in the pre-existing output language to be expectedly outputted by the frozen pre-existing decoder in response to the input training-data through the arbitrary intermediate representation, thereby causing
adjustment of the encoding parameters of the new encoder, such that the new encoder results trained to translate from the new input language through converging to the arbitrary intermediate representation.

9. A method of training a multilingual translator according to claim 8, the new encoder being a new speech encoder and the pre-existing decoder being a pre-existing text decoder.

10. A method of training a multilingual translator according to claim 9, further comprising:
projecting values or points generated by the new speech encoder within the arbitrary intermediate representation into an arbitrary middle representation with larger or smaller dimensionality than the arbitrary intermediate representation;
projecting values or points resulting from the projection into the arbitrary middle representation back into the arbitrary intermediate representation; and
adding values or points resulting from the projection back into the arbitrary intermediate representation to the values or points generated by the new speech encoder before the projection into the arbitrary middle representation.

11. A method of training a multilingual translator according to claim 10, further comprising normalizing the values or points generated by the new speech encoder before the projection into the arbitrary middle representation.

12. A method of training a multilingual translator according to claim 10 the dimensionality of the arbitrary middle representation being selected larger or smaller than the arbitrary intermediate representation experimentally, depending on an accuracy level achieved with the larger or smaller dimensionality.

13. A method of training a multilingual translator according to claim 10 further comprising pre-training the new speech encoder with an auxiliary text decoder before its training with the pre-existing text decoder, said pre-training including:
iteratively providing the new speech encoder and the auxiliary text decoder with respective input and output training-data pair including input speech training-data in the new input language, and output text training-data also in the new input language to be expectedly outputted by the auxiliary text decoder in response to the input speech training-data, thereby causing
pre-adjustment of the encoding parameters of the new speech encoder, such that the posterior training of the new speech encoder with the pre-existing text decoder will result more accurate with less input and output training-data.

14. A method of training a multilingual translator that has been previously trained with a method according to claim 7, for adding a new translation direction from a pre-existing input language to a new output language, the method comprising:
freezing the pre-existing encoder whose input language is the pre-existing input language, such that the encoding parameters of the pre-existing encoder are set as non-modifiable; and
iteratively providing the frozen pre-existing encoder and a new decoder of the new translation direction with respective input and output training-data pair including input training-data in the pre-existing input language, and output training-data in the new output language to be expectedly outputted by the new decoder in response to the input training-data through the arbitrary intermediate representation, thereby causing
adjustment of the decoding parameters of the new decoder, such that the new decoder results trained to translate to the new output language through converging to the arbitrary intermediate representation.

15. A computing system for training a multilingual translator, the computing system comprising a memory and a processor, embodying instructions stored in the memory and executable by the processor, the instructions comprising functionality or functionalities to execute a method according to claim 7 of training a multilingual translator.

16. A computer program comprising program instructions for causing a computing system to perform a method according to claim 7 of training a multilingual translator.

17. A computer program according to claim 16, embodied on a storage medium.

18. A computer program according to claim 16, carried on a carrier signal.
